(19) United States
(12) Patent Application Publication
(10) Pub. No.: US 2025/0020909 A1
(43) Pub. Date: Jan. 16, 2025

(54) UNIVERSAL COMPACT BINOCULAR HEADREST

(71) Applicant: Tyler R. Hopp, Fort Collins, CO (US)

(72) Inventor: Tyler R. Hopp, Fort Collins, CO (US)

(21) Appl. No.: 18/767,362

(22) Filed: Jul. 9, 2024

Related U.S. Application Data
(60) Provisional application No. 63/513,167, filed on Jul. 12, 2023.

(51) Int. Cl. G02B 23/18

(52) U.S. Cl. CPC G02B 23/18

(57) ABSTRACT

Disclosed herein is a headrest device and method of use for stabilizing binoculars. The device provides for three points of contact on the face of a user, as opposed to the conventional two points of contact. The device can include a connector, a wrap-around structure, and a stabilizing support member. The connector can releasably couple to a tripod connector on the binoculars. The wrap-around structure can include a body having a first end, a second end, and adjustable section. When the connector releasably connects to the tripod connector, the adjustable section is positioned lengthwise along the mid-section of the binoculars and the second end is positioned above the eyepieces of the pair of barrels of the binoculars so as to centrally position the stabilizing support member for supporting the forehead of the user.

### CROSS-REFERENCE TO RELATED APPLICATION

This application claims the benefit of U.S. Provisional Application No. 63/513,167, filed Jul. 12, 2023, which is hereby incorporated by reference in its entirety for all purposes.

### FIELD OF THE INVENTION

The present disclosure is directed to a device and method for stabilizing binoculars. More specifically, the present disclosure is directed to a universal compact binocular headrest and method of use.

### BACKGROUND OF THE INVENTION

Conventionally, people use hand-held binoculars recreationally for activities such as bird watching and hunting, among other personal uses. Binoculars are available in a wide variety of sizes and having a wide variety of features. Conventionally, tripods that are supported on the ground by three legs have been used to stabilize binoculars during use, especially at higher magnifications, thereby reducing shake and stabilizing the field of view for the user. However, binocular users may find it inconvenient to carry around, set up, and otherwise use a tripod in conjunction with binoculars.

Accordingly, there is a need in the art for a device and method to stabilize binoculars that is convenient to use, smaller in size, and less bulky than a tripod. It is with these thoughts in mind, among others, that the universal compact binocular headrest and method of use was developed.

### SUMMARY

Aspects of the present disclosure include a headrest device for stabilizing binoculars. The binoculars may include a body extending from a user-facing end to an object-facing end. The body can include a pair of barrels coupled together at a mid-section thereof, a focus knob at the user-facing end, and a tripod connector at the object-facing end (e.g., positioned opposite the focus knob). Each of the pair of barrels can include an eyepiece at the user-facing end and an objective lens at the object-facing end.

In certain instances, the headrest device includes a connector, a wrap-around structure, and a stabilizing support member. The connector can be releasably coupled to the tripod connector of the binoculars, thereby coupling the headrest device to the binoculars. The wrap-around structure can include a body that extends from a first end to a second end opposite the first end. The body can include an adjustable section. The first end can of the body have an aperture for receiving the connector therethrough, which can releasably couple the headrest device to the binoculars. The second end of the body can be coupled to the stabilizing support member. When the connector extends through the aperture and is releasably connected to the tripod connector, the adjustable section of the body can be positioned lengthwise along the mid-section of the binoculars. Additionally, when the connector extends through the aperture and is releasably connected to the tripod connector, the second end of the body can be positioned above the eyepieces of the pair of barrels to centrally position the stabilizing support member for supporting the forehead of the user.

### BRIEF DESCRIPTION OF THE DRAWINGS

FIGS. 1A-1F illustrate one instance of a headrest device coupled to a pair of binoculars, in accordance with embodiments of the disclosure. FIGS. 1A-1F illustrate, respectively, a front view, a rear view, a right-side view, a left-side view, a top view, and a bottom view.

FIGS. 2A-2D illustrate the headrest device from FIGS. 1A-1F, when decoupled from the binoculars, in accordance with embodiments of the disclosure. FIGS. 2A-2D illustrate, respectively, a perspective right-side view, a perspective left-side view, a right-side view, and a left-side view.

FIGS. 3A-3E illustrate one instance of a headrest device coupled to a pair of binoculars, in accordance with embodiments of the disclosure. FIGS. 3A-3C illustrate, respectively, a perspective right-side view, a perspective right-side view, and a perspective left-side view. FIGS. 3D-3E illustrate perspective close-up views of an adjustable connection to the binoculars, in accordance with embodiments of the disclosure.

FIGS. 4A-4B illustrate one instance of a headrest device coupled to a pair of binoculars, in accordance with embodiments of the disclosure. FIGS. 4A-4B illustrate a perspective rear-view and a perspective front-view, respectively.

### DETAILED DESCRIPTION

Provided herein is a binocular headrest (also referred to as a stabilization device) that can be mounted (e.g., connected) to a pair of binoculars and then used to stabilize the binoculars when a user looks through the binoculars. The height and length of the binocular headrest can be adjusted in accordance with the specific pair of binoculars and/or the specific user. Various embodiments of the presently disclosed binocular headrest are described herein. The components of each of individually described binocular headrest can be applied to any of the other binocular headrests without limitation. The stabilization device functions by providing a stabilizing surface (e.g., pad) that is supported by the user's forehead that, when used in conjunction with the eye cups against each eye, provides three points of contact that stabilize the binoculars. In particular, movement of the binoculars up-and-down is stabilized by adding this third point of contact at the forehead of the user.

The binocular headrest includes a first end that can be secured to the binoculars and a second end, which is opposite the first end, that has a resting pad (also referred to as a headrest). To mount the binocular headrest to the binoculars, a thumb screw can be used to secure the first end of the binocular headrest to the tripod interface of the binoculars. The first end of the binocular headrest can include a vertical slot, such that the height (e.g., vertical position) of the binocular headrest can be adjusted. The second end of the binocular headrest can include multiple vertically arranged apertures that can receive the resting pad therethrough, such that the height (e.g., vertical position) of the binocular headrest can be adjusted. A threaded rod can be included between the first end and the second end of the binocular headrest, such that the length (e.g., horizontal position) of the binocular headrest can be adjusted. When the binocular headrest is mounted to the binoculars and properly adjusted for height and length as a 3 PATENT APPLICATION user looks through the binoculars, the resting pad can be positioned against the forehead of the user such that the binocular headrest stabilizes the binoculars (which stabilizes the field of view).

The binocular headrest can be universally installed onto any pair of binoculars that has a tripod interface and adjusted according to the binoculars and/or user. To accommodate a specific pair of binoculars to which the headrest is attached, the binocular headrest can be adjusted (e.g., length, height) according to the dimensions of the binoculars (e.g., compact, midsize, or full-size binoculars). To accommodate the specific needs or preferences of the user who is looking through the binoculars, the binocular headrest can be adjusted (e.g., length, height) to position the resting pad on the forehead of the user.

In this manner, the binocular headrest is modular (e.g., interchangeable) with any pair of binoculars that has a tripod interface. For instance, the binocular headrest can be interchangeably coupled to a first pair of binoculars (e.g., compact, midsize, or full-size binoculars) and adjusted for both the binoculars and the user. The binocular headrest can remain interchangeably coupled to the first pair of binoculars and can be adjusted for a second user. The binocular headrest can be removed and interchangeably coupled to a second pair of binoculars and adjusted for both the binoculars and the user.

The binocular headrest may have significant advantages over conventional binocular stabilization devices. As one example of an advantage over conventional stabilization devices, the presently disclosed binocular headrest is modular such that it can be universally installed onto any pair of binoculars having a tripod interface (e.g., threaded interface on object-side of binoculars) and adjusted according to the binoculars and/or user. The modular ability to fit the binocular headrest onto different pairs of binoculars (e.g., different sizes of binoculars) is desirable because, as one example, different pairs of binoculars may be used for different recreational endeavors.

As another example of an advantage over conventional stabilization devices, the presently disclosed binocular headrest may be more ergonomic than conventional stabilization devices. For example, the presently disclosed binocular headrest may allow easier access to (e.g., reduce interference with) the focus knob, the two barrels, the two eyecups, and/or diopter of the binoculars. The presently disclosed binocular headrest can wrap underneath the hinge of the binoculars (e.g., when the binoculars are in a horizontal position), such that at least a portion of the binocular headrest is between the two barrels of the binoculars. Typically, the hinge is on the top side when the binoculars are in a horizontal position (e.g., the hinge of the binoculars is above the centerlines of the two barrels of the binoculars), and the focus knob is aligned with the hinge (e.g., on the top side of the binoculars). The underneath orientation (e.g., wrapping the binocular headrest underneath the hinge) may allow easier access to (e.g., reduce interference with) the focus knob, whereas wrapping the binocular headrest over the top of the binocular hinge may block or otherwise impede access to the focus knob. Moreover, the underneath orientation may allow easier access to the two barrels, the two eyecups, and/or diopter of the binoculars because at least a portion of the binocular headrest is between the two barrels.

As another example of an advantage over conventional stabilization devices, the presently disclosed binocular headrest may be more compact than other stabilization devices. As discussed previously, the binocular headrest can wrap underneath the hinge of the binoculars, such that at least a portion of the binocular headrest is between the two barrels of the binoculars. This design may be more compact than a tripod assembly. Moreover, this design may be more compact than wrapping the binocular headrest over the top of the binocular hinge because at least a portion of the binocular headrest is between the two barrels. In other words, if the binocular headrest wrapped over the top of the hinge, then the binocular headrest extends outwards from (e.g., above) the hinge. The compact design of wrapping the binocular headrest underneath the hinge may allow the binocular headrest to fit inside a binocular bag or case more easily. For example, in some instances, the binocular headrest can remain attached to the binoculars when the assembly is stored in a binocular bag or case. In some instances, the stabilization device described herein may wrap around the topside of the hinge.

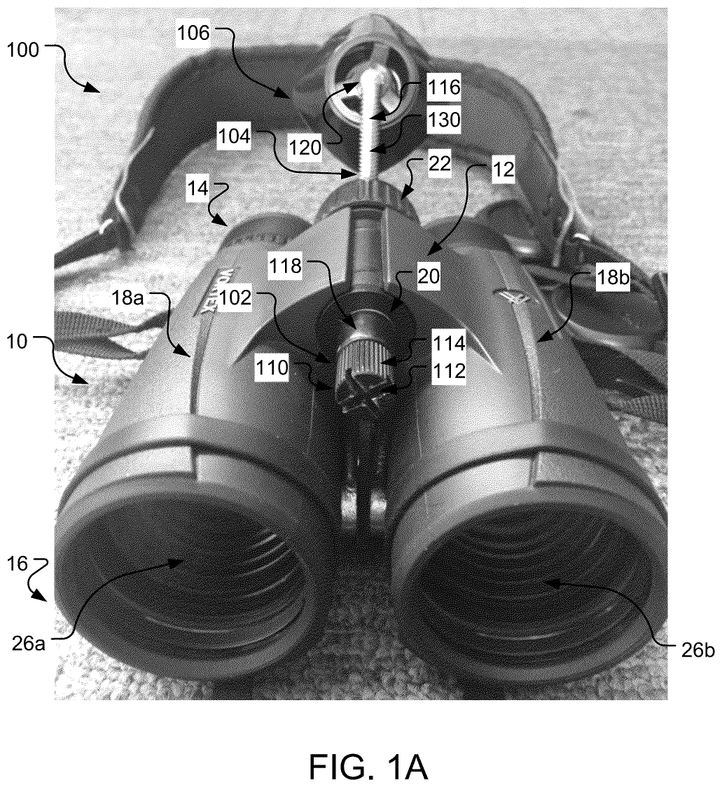

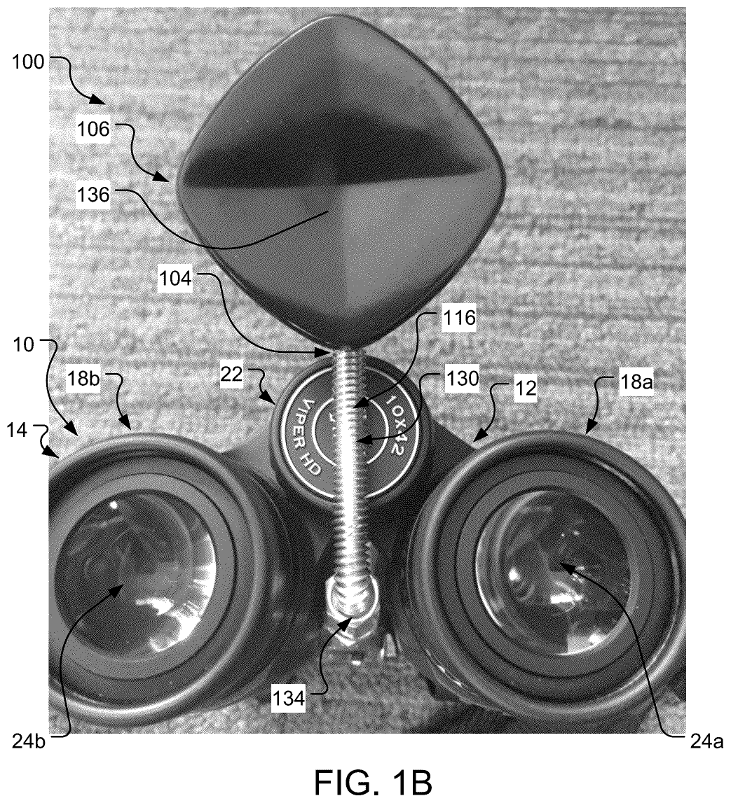

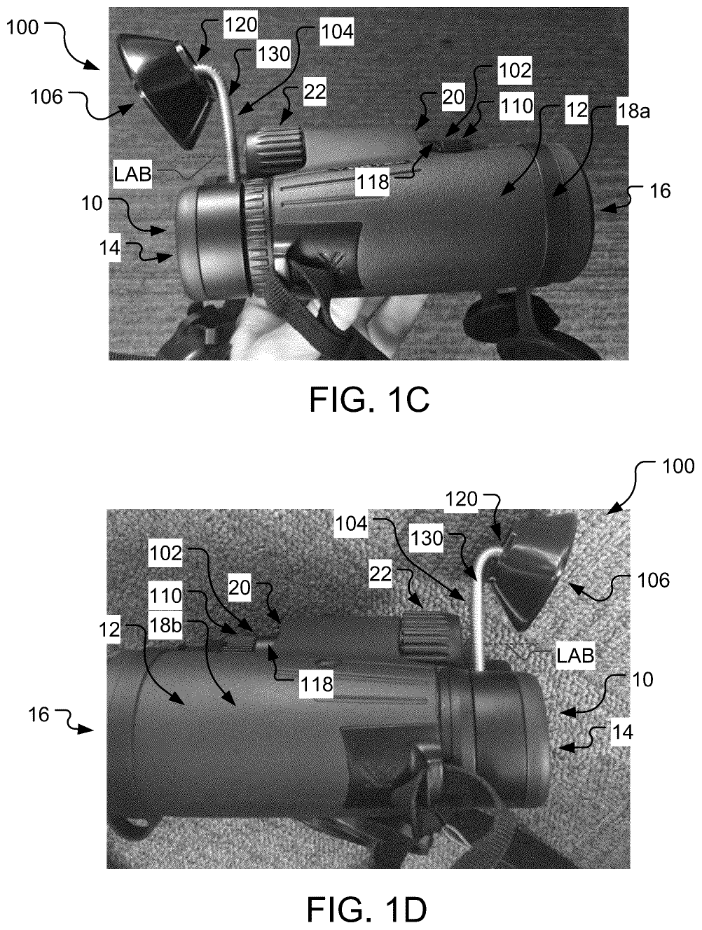

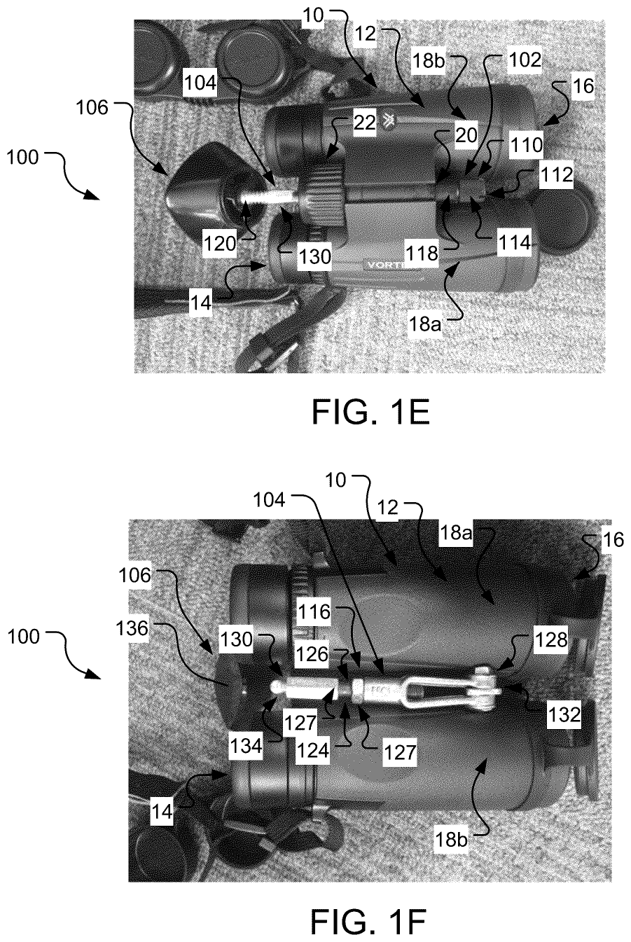

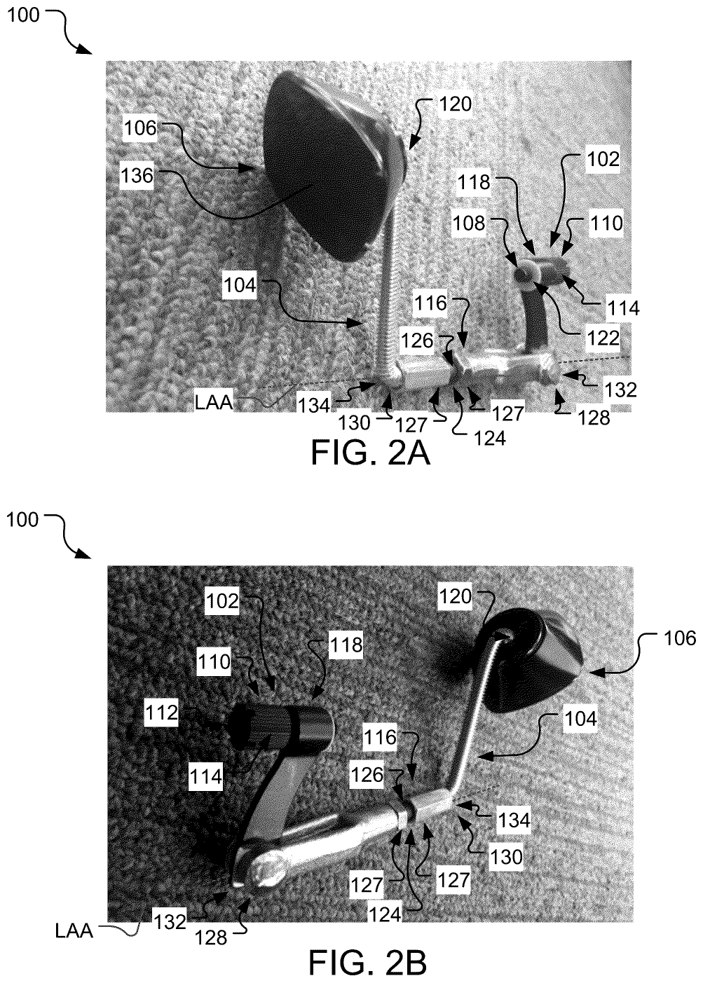

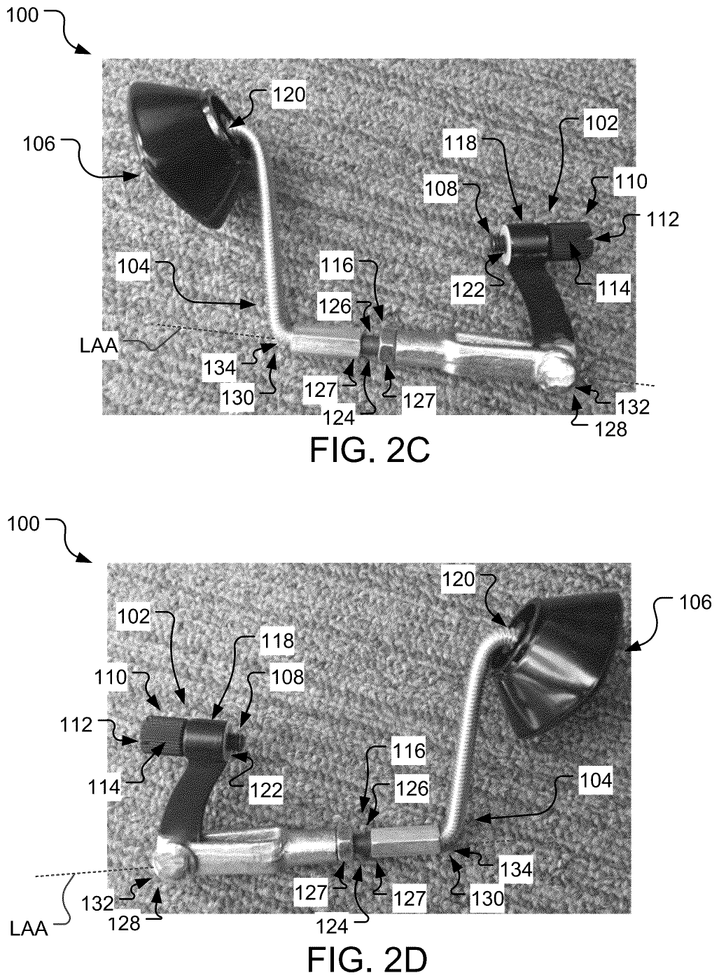

FIGS. 1A-1F and FIGS. 2A-2D illustrate one instance of a headrest device 100. The headrest device 100 can be coupled (e.g., removably coupled) to a pair of binoculars 10 as illustrated in FIGS. 1A-1F, which illustrate a front-perspective view, rear-view, right-side view, left-side view, top view, and bottom view, respectively. The length and/or height of the headrest device 100 can be adjusted, such that the headrest device 100 can accommodate binoculars 10 of various sizes (e.g., compact, midsize, full-size) and various user preferences (e.g., horizontal position of the binoculars 10 with respect to the user during viewing, vertical distance between the eyes of the user and the forehead of the user). When a user looks through the binoculars 10 for viewing, the headrest device 100 can be positioned against the forehead of the user to stabilize binoculars 10. The headrest device 100 can be decoupled from the binoculars 10, as illustrated for example in FIGS. 2A-2D, which illustrate a perspective-rear view, a perspective front-view, a right-side view, and a left-side view, respectively.

As discussed previously, the headrest device 100 can be coupled to any pair of binoculars 10 that has a tripod connector 20 (also referred to as a tripod interface). Nevertheless, an exemplary pair of binoculars 10 that has a tripod connector 20, as illustrated for example in FIGS. 1A-1F, is described herein for reference. The binoculars 10 have a body 12 that extends from a user-facing end 14 to an object-facing end 16. The body 12 includes a pair of barrels 18 (e.g., 18a, 18b) that are coupled together at a mid-section of the body 12 (e.g., a hinge). The mid-section of the body 12 of the binoculars 10 can define a longitudinal axis LAB of the body 12, as best illustrated in the side-views in FIGS. 1C-1D.

The binoculars 10 include a tripod connector 20 (also referred to as a tripod interface), which can be towards the object-facing end 16 of the binoculars. The tripod connector 20 can include a threaded socket that can receive a threaded connector (e.g., bolt, screw). For example, the tripod connector 20 of the binoculars 10 can be a ¼″-20 female thread. The binoculars 10 can include a focus knob 22, which can be towards the user-facing end 14 of the binoculars 10. In other words, the tripod connector 20 can be opposite the focus knob 22. Each of the pair of barrels 18a, 18b can include an eyepiece 24 (e.g., 24a, 24b) at the user-facing end 14 and an objective lens 26 (e.g., 26a, 26b) at the object-facing end 16.

The headrest device 100 includes a connector 102, a wrap-around structure 104, and a stabilization support member 106. The connector 102 can be releasably coupled to the tripod connector 20. The wrap-around structure 104 extends from the connector 102 to the stabilization support member 106. The stabilization support member 106 can be positioned against the forehead of a user to stabilize the binoculars 10 (e.g., stabilize the field of view) when the user is looking through the binoculars 10.

The disclosure turns more specifically now to the connector 102. The connector 102 can be releasably coupled (or removably coupled) to the tripod connector 20 of binoculars 10, thereby releasably coupling the headrest device 100 the binoculars 10. In other words, the connector 102 can be releasably coupled to the tripod connector 20 to couple the headrest device 100 to the binoculars 10, as illustrated for example in FIGS. 1A-1F. Similarly, the connector 102 can be removed (e.g., released) from the tripod connector 20 to decouple the headrest device 100 from the binoculars 10, as illustrated for example in FIGS. 2A-2D.

In some instances, the connector 102 includes a threaded end 108 and a head 110 opposite the threaded end 108, as best illustrated in FIGS. 2A-2D. The threaded portion (e.g., male threads) of the threaded end 108 of the connector 102 correspond to the threaded portion (e.g., female threads) of the tripod connector 20. For example, the threaded end 108 of the connector 102 can be a ¼″-20 male thread. To releasably couple (e.g., attach) the headrest device 100 to the binoculars 10, as illustrated in FIGS. 1A-1F, the threaded end 108 of the connector 102 can be threadably advanced (e.g., inserted, fastened, tightened) into the tripod connector 20 (e.g., by rotating the head 110 in a clockwise direction) such that the threaded end 108 is threadably received within the tripod connector 20. In other words, the threads of the threaded end 108 of the connector 102 engage the threads of the tripod connector 20 to releasably couple the headrest device 100 to the binoculars 10. To release (e.g., decouple, separate) the headrest device 100 from the binoculars 10, the threaded end 108 can be threadably withdrawn (e.g., removed, unfastened, loosened) from the tripod connector 20 (e.g., by rotating the head 110 in a counterclockwise direction).

The head 110 of the connector 102 defines a cross-sectional diameter that is greater than the cross-sectional diameter of the threaded end 108 of the connector 102. When the threaded end 108 is threadably advanced into the tripod connector 20, an inner-face of the head 110 can abut the wrap-around structure 104 to maintain the position of the wrap-around structure 104 with respect to the binoculars 10.

In some instances, the head 110 can include a drive recess 112 (e.g., frearson, slotted, hex socket, allen drive) and/or a grip surface 114 (e.g., ribbed). In this manner, a tool (e.g., inserted into the drive recess 112) and/or hand (e.g., gripping the grip surface 114) can be used to rotate the head 110. A tool (e.g., screwdriver, allen wrench) corresponding to the drive recess 112 can be provided with a kit that contains the headrest device 100, such that the tool can be used to rotate the head 110 of the connector 102. As discussed previously, rotating the head 110 (e.g., clockwise) can threadably advance the threaded end 108 into the tripod connector 20, thereby releasably coupling the connector 102 to the tripod connector 20. Similarly, rotating the head 110 (e.g., counterclockwise) can threadably withdraw the threaded end 108 from the tripod connector 20, thereby decoupling the connector 102 from the tripod connector 20.

The disclosure turns more specifically now to the wrap-around structure 104. The wrap-around structure 104 extends from the connector 102 (as previously discussed) to the stabilization support member 106 (as subsequently discussed). In other words, when the headrest device 100 is releasably coupled to the binoculars 10 and used to stabilize binoculars 10 as a user looks through the binoculars, the wrap-around structure 104 extends from the tripod connector 20 towards the forehead of the user.

The wrap-around structure 104 includes a body 116 having a first end 118 and a second end 120 opposite the first end 118, as best illustrated in FIGS. 2A-2D. The first end 118 can include an aperture 122 configured to receive the connector 102 therethrough, such that the connector 102 can releasably couple the headrest device 100 to the binoculars 10 (e.g., to the tripod connector 20) as previously discussed. The second end 120 can be configured to couple to the stabilization support member 106. When the headrest device 100 is coupled to the binoculars 10 (e.g., when the connector 102 extends through the aperture 122 and is releasably coupled to the tripod connector 20), the body 116 of the wrap-around structure 104 can wrap below (e.g., underside) the hinge of the binoculars 10 such that at least a portion of the body 116 is between the two barrels 18a, 18b of the binoculars 10.

The body 116 of the wrap-around structure 104 includes an adjustable section 124, which defines a longitudinal axis LAA. The length (e.g., horizontal position) of the adjustable section 124 is adjustable, such that changing the length of the adjustable section 124 correspondingly changes the length of the body 116 of the wrap-around structure 104. In other words, the adjustable section 124 can be lengthened (e.g., extended), thereby increasing the length of the body 116. Similarly, the adjustable section 124 can be shortened (e.g., retracted), thereby reducing the length of the body 116. In this manner, the headrest device 100 can be adjusted to accommodate a specific pair of binoculars 10 (e.g., size of the binoculars 10) and/or preferences of the user.

When the headrest device 100 is releasably coupled to the binoculars 10, the adjustable section 124 can be positioned lengthwise along the mid-section of the binoculars 10. In other words, the longitudinal axis LAA of the adjustable section 124 is co-planar to the midsection of the binoculars 10 (e.g., co-planar with the longitudinal axis LAB of the body 12 of the binoculars 10). In some examples, the longitudinal axis LAB of the adjustable section 124 is parallel to the midsection of the binoculars 10. In other words, when the binoculars 10 are substantially horizontal in orientation, the longitudinal axis LAB of the adjustable section 124 is substantially horizontal.

When the headrest device 100 is releasably coupled to the binoculars 10, the second end 120 of the body 116 can be positioned above the centerlines of the eyepieces 24a, 24b of the barrels 18a, 18b. In some examples, the second end 120 of the body 116 can be positioned above the eyepieces 24a, 24b. Thus, when a user is using the binoculars 10 (e.g., looking through the eyepieces 24a, 24b), the stabilization support member 106 can support the forehead of the user.

The adjustable section 124 defines a member 126 configured to couple between a first member 128 (which includes the first end 118) and a second member 130 (which includes the second end 120). In some embodiments, the member 126 is a threaded rod between the first member 128 and the second member 130. For example, a locking mechanism 127 (e.g., threaded locking nut) can be included at each end of the adjustable section 124 and used to secure the member 126 in place, such that the length of the adjustable section 124 is fixed (e.g., during use of the headrest device 100).

In some embodiments, the wrap-around structure 104 can releasably couple to the tripod connector 20 of the binoculars 10 and wrap around the underside (e.g., below) the hinge that joins the barrels 18a, 18b of the binoculars 10. For example, the first member 128 can extend substantially vertically downward (e.g., from the first end 118 of the wrap-around structure 104 that is coupled to the tripod connector 20) and substantially horizontally rearward (e.g., towards the eyepieces 24a, 24b of the binoculars 10). The adjustable section 124 can extend substantially horizontally rearward (e.g., towards the eyepieces 24a, 24b of the binoculars 10) from the first member 128. The second member 130 can extend substantially horizontally rearward (e.g., towards the eyepieces 24a, 24b of the binoculars 10) and substantially vertically upwards (e.g., towards the forehead of the user) from the adjustable section 124.

In some embodiments, the first member 128 has an elbow 132 (e.g., first elbow section). The elbow 132 can join a substantially vertical section of the first member 128 and a substantially horizontal section of the first member 128. When the headrest device 100 is releasably coupled to the binoculars 10, the substantially vertical section of the first member 128 can extend vertically downwards from the connector 102, which is connected to the tripod connector 20. The substantially horizontal section of the first member 128 can extend horizontally rearwards (e.g., in the direction of the eyepieces 24a, 24b of the binoculars 10). In some examples, a longitudinal axis of the substantially horizontal section of the first member 128 can be coincident with the longitudinal axis LAA of the adjustable section 124. The first member 128 can be constructed of one piece or, in some examples, the first member 128 can be constructed of more than one piece.

In some embodiments, the second member 130 has an elbow 134 (e.g., second elbow section). The elbow 134 can join a substantially vertical section of the second member 130 and a substantially horizontal section of the second member 130. When the headrest device 100 is releasably coupled to the binoculars 10, the substantially vertical section of the second member 130 can extend vertically downwards from the stabilization support member 106, which can be positioned on the forehead of the user. The substantially horizontal section of the second member 130 can extend horizontally forwards (e.g., in the direction of the objective lenses 26a, 26b of the binoculars 10). In some examples, a longitudinal axis of the substantially horizontal section of the second member 130 can be coincident with the longitudinal axis LAA of the adjustable section 124. The second member 130 can be constructed of one piece or, in some examples, the second member 130 can be constructed of more than one piece.

The disclosure turns more specifically now to the stabilization support member 106. The stabilization support member 106 can be coupled to the wrap-around structure 104 and the stabilization support member 106 is operable to be in contact with (e.g., support) the forehead of the user. When the headrest device 100 is releasably coupled to the binoculars 10 and a user looking through the binoculars 10, the stabilization support member 106 can be positioned against the forehead of the user (e.g., the stabilization support member 106 can support the forehead of the user). In this manner, the stabilization support member 106 reduces shake and stabilizes the field of view through the binoculars 10 by stabilizing the binoculars 10 (e.g., via the headrest device 100) against the forehead of the user.

The stabilization support member 106 defines an inner-facing surface 136, which abuts (e.g., contacts), in whole or in part, the forehead of the user when the stabilization support member 106 is positioned against the forehead of the user. In some embodiments, the inner-facing surface 136 can be configured to have multiple points of contact with the head of the user. For example, the inner-facing surface 136 can include multiple surfaces that form a general pyramid shape, wherein portions of one or more of the surfaces can contact the forehead of the user. As another example, the inner-facing surface 136 can be substantially concave such that multiple points can contact the forehead of the user. In some embodiments, the inner-facing surface 136 of the stabilization support member 106 is constructed out of polymer.

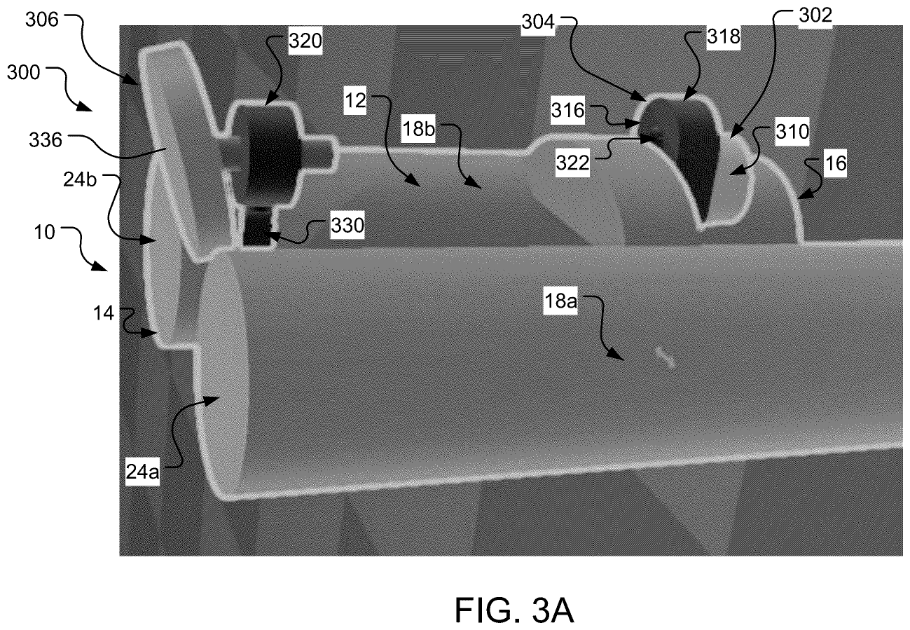

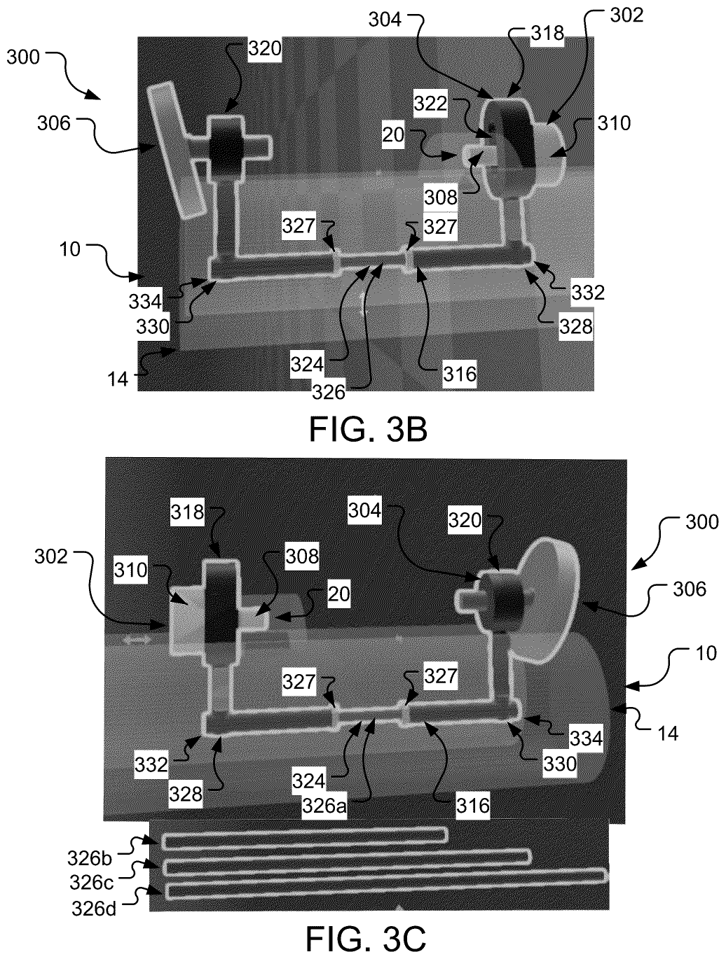

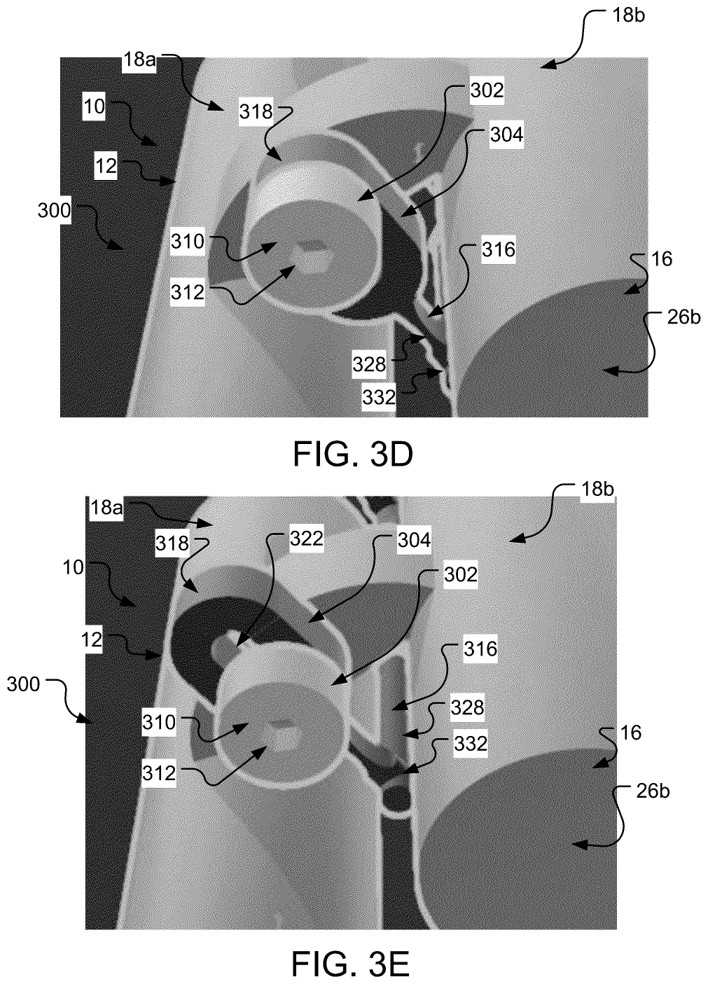

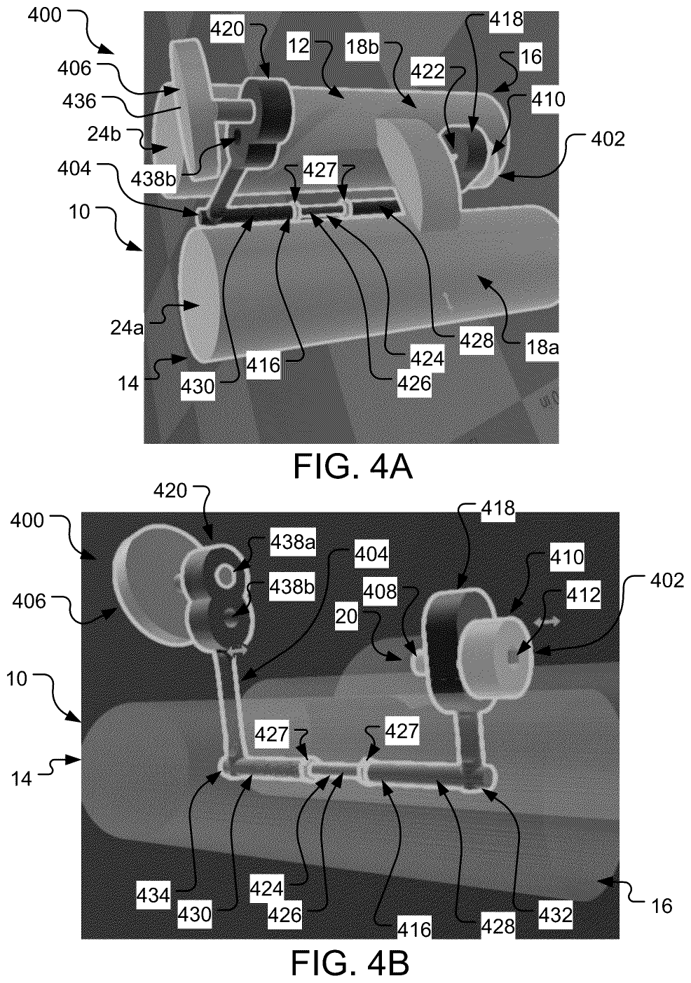

The horizontal position of the stabilization support member 106 can be adjusted by adjusting the length (e.g., horizontal position) of the adjustable section 124 of the wrap-around structure 104, as previously discussed. The vertical position of the stabilization support member 106 can be adjusted as discussed below and with respect to FIGS. 3A-3E and FIGS. 4A-4B. In some examples, when the stabilization support member 106 is horizontally and vertically positioned to contact the forehead of a user, a distance between the centerline of the stabilization support member 106 and a centerline of either of the eyepieces 24a, 24b of the binoculars 10 can be between approximately 1.5-inches and 3-inches. The distance can be adjusted by the user in accordance with the preferences of the user. For example, the distance can be approximately 1.85-inches, 2.0-inches, 2.25-inches, or 2.5-inches in various positions.

The stabilization support member 106 can be centrally positioned (e.g., such that it can support the forehead of the user) when the headrest device 100 is coupled to the binoculars 10. The center point of the stabilization support member 106 can be co-planar with the longitudinal axis LAA of the adjustable section 124 and the longitudinal axis LAB of the body 12 of the binoculars 10. In this manner, the distance between the right eyepiece 24a and the centerline of the stabilization support member 106 can be equal to the distance between the left eyepiece 24b and the centerline of the stabilization support member 106.

In some embodiments, the stabilization support member 106 can be pivotally coupled to the wrap-around structure 104, such that the stabilization support member 106 can pivot about the second end 120 of the wrap-around structure 104. For example, the inner-facing surface 136 of the stabilization support member 106 can be pivoted (e.g., rotated) to face partially upwards or partially downwards so that it can support the forehead of the user. In some embodiments, the pivotal coupling can include a pivoting hinge. In other embodiments, the pivotal coupling can include a ball and socket (e.g., the second end 120 of the wrap-around structure 104 can include a ball and the stabilization support member 106 can include a socket that receives the ball at the second end 120 of the wrap-around structure 104).

When the stabilization support member 106 supports the forehead of the user (e.g., when the user is using the headrest device 100 to stabilize the binoculars 10), the headrest device 100 can inhibit movement (e.g., lateral movement, rotational movement) of the binoculars 10. For example, when in contact with the forehead of the user, the stabilization support member 106 can inhibit lateral movement (e.g., rearward movement along the longitudinal axis LAB) of the binoculars 10. As another example, when in contact with the forehead of the user, the stabilization support member 106 can inhibit rotational movement (e.g., rotational movement about the longitudinal axis LAB) of the binoculars 10. In other words, the stabilization support member 106 can inhibit shake (e.g., rotational movement about the eyepieces 24a, 24b of the binoculars 10). In this manner, the stabilization support member 106 stabilizes the field of view for the user looking through the binoculars 10.

FIGS. 3A-3E illustrate another exemplary embodiment of a headrest device 300, in accordance with one or more aspects of the present disclosure. For example, FIGS. 3A-3C illustrate, respectively, a perspective right-side view, a perspective right-side view, and a perspective left-side view of the headrest device 300 coupled (e.g., releasably coupled) to binoculars 10. The binoculars 10 are illustrated as translucent in FIGS. 3B-3C to illustrate the portions of the headrest device 300 that would otherwise be obstructed by solid binoculars. FIGS. 3D-3E illustrate perspective close-up views of an adjustable connection to the binoculars 10.

The headrest device 300 illustrated in FIGS. 3A-3E can include one or more same or similar features as those described above with respect to the headrest device 100 in FIGS. 1A-1F and FIGS. 2A-2D. Due to the same or similar features, the reference numbers and corresponding description provided above for various components, elements, portions, etc., included in the headrest device 100 in FIGS. 1A-1F and FIGS. 2A-2D can be generally applied to the same or similar components, elements, portions, etc., included in the headrest device 300 described in FIGS. 3A-3E; however, the reference numbers in FIGS. 3A-3E are 300 series rather than 100 series.

For example, the headrest device 300 illustrated in FIGS. 3A-3E can be coupled (e.g., removably coupled) to a pair of binoculars 10. The length of the adjustable section 324 of the body 316 of the wrap-around structure 304 can be adjusted to accommodate the specific pair of binoculars 10 (e.g., size of the binoculars 10). The height of the stabilization support member 306 can be adjusted in to accommodate the specific pair of binoculars 10. The stabilization support member 306 can be positioned against the forehead of a user to stabilize the field of view for the user looking through the binoculars 10.

As illustrated in FIGS. 3A-3E, the first end 318 of the body 316 of the wrap-around structure 304 can be height (e.g., vertical position) adjustable, such that the height of the stabilization support member 306 can be positioned at different heights on the forehead of the user. For example, the aperture 322 at the first end 318 of the body 316 of the wrap-around structure 304 can be an elongated aperture 322 (e.g., a slot), such that the headrest device 300 can be adjusted to various heights (e.g., coupled to the binoculars 10 at different heights with respect to the binoculars 10). The connector 302 can be releasably coupled (or removably coupled) to the tripod connector 20 of the binoculars 10 at different positions along the length of the elongated aperture 322, thereby releasably coupling the headrest device 300 to the binoculars 10 at different heights. In this manner, the elongated aperture 322 provides an adjustable connection point to releasably secure the connector 302 of the headrest device 300 to the tripod connector 20 of the binoculars 10.

The headrest device 300 can be moved substantially vertically (e.g., upwards, downwards) along the elongated aperture 322 to position the headrest device 300 in a desired position (e.g., with the connector 302 not fully tightened). Then, the connector 302 can be fully tightened (e.g., advanced into the tripod connector 20) to releasably couple the headrest device 300 in the desired position. In this manner, the elongated aperture 322 can be used to adjust the position of the stabilization support member 306 with respect to the binoculars 10. For example, in FIG. 3D, the connector 302 is near the top of the elongated aperture 322 at the first end 318 of the wrap-around structure 304, such that the stabilization support member 306 is in a lower vertical position. On the other hand, in FIG. 3E, the connector 302 is near the bottom the elongated aperture 322 at the first end 318 of the wrap-around structure 304, such that the stabilization support member 306 is in a higher vertical position.

As illustrated in FIG. 3C, the headrest device 300 can include interchangeable members 326 (e.g., 326a, 326b, 326c, 326d) (e.g., threaded rods) for the adjustable section 324 of the wrap-around structure 304. The members 326 can be used interchangeably to adjust the length (e.g., horizontal position) of the headrest device 300. In some embodiments, the members 326a, 326b, 326c, 326d (e.g., threaded rods) can have different lengths and can be interchangeably installed within the adjustable section 324. In some examples, the length of the members 326 can range from approximately 2-inches to approximately 5-inches. For example, a member 326 can be approximately 2-inches in length, approximately 3-inches in length, approximately 4-inches in length, or approximately 5-inches in length. A locking mechanism 327 (e.g., threaded locking nut) at each end of the adjustable section 324 can be used to secure the member 326 in place, such that the length of the adjustable section 324 is fixed (e.g., during use of the headrest device 300).

For example, when the headrest device 300 is used with a relatively shorter pair of binoculars 10, a member 326 having a relatively shorter length (e.g., member 326a) (e.g., a relatively shorter threaded rod) can be installed in the adjustable section 324 to reduce the length of the wrap-around structure 304 (e.g., shorten the headrest device 300). Similarly, when the headrest device 300 is used with a relatively longer pair of binoculars 10, a member 326 having a relatively longer length (e.g., member 326d) (e.g., a relatively longer threaded rod) can be installed in the adjustable section 324 to increase the length of the wrap-around structure 304 (e.g., lengthen the headrest device 300). In some embodiments, the multiple interchangeable members 326 (e.g., threaded rods) can be included in a kit that is used to package the headrest device 300. For example, as illustrated in FIG. 3C, the kit can include four members 326 (e.g., 326a, 326b, 326c, 326d).

FIGS. 4A-4B illustrate another exemplary embodiment of a headrest device 400, in accordance with one or more aspects of the present disclosure. For example, FIGS. 4A-4B illustrate, respectively, a perspective rear-view of the headrest device 400 coupled (e.g., releasably coupled) to binoculars 10 and a perspective front-view of the headrest device 400 coupled to translucent binoculars 10.

The headrest device 400 illustrated in FIGS. 4A-4B can include one or more same or similar features as those described above with respect to the headrest device 100 in FIGS. 1A-1F and FIGS. 2A-2D and the headrest device 300 in FIGS. 3A-3E. Due to the same or similar features, the reference numbers and corresponding description provided above for various components, elements, portions, etc., included in the headrest device 100 in FIGS. 1A-1F and FIGS. 2A-2D and the headrest device 300 in FIGS. 3A-3E can be generally applied to the same or similar components, elements, portions, etc., included in the headrest device 400 described in FIGS. 4A-4B; however, the reference numbers in FIGS. 4A-4B are 400 series rather than 100 series and/or 300 series.

For example, the headrest device 400 illustrated in FIGS. 4A-4B can be coupled (e.g., removably coupled) to a pair of binoculars 10. The length of the adjustable section 424 of the body 416 of the wrap-around structure 404 can be adjusted to accommodate the specific pair of binoculars 10 (e.g., size of the binoculars 10). The height of the stabilization support member 406 can be adjusted in to accommodate the specific pair of binoculars 10. The stabilization support member 406 can be positioned against the forehead of a user to stabilize the field of view for the user looking through the binoculars 10.

As illustrated in FIGS. 4A-4B, the second end 420 of the body 416 of the wrap-around structure 404 can accommodate height adjustments (e.g., vertical position) of the stabilization support member 406. In this manner, the stabilization support member 406 can be positioned at different heights on the forehead of the user. For example, the second end 420 can include more than one aperture 438 (e.g., 438a, 438b), such that the headrest device 400 can be adjusted to various heights (e.g., coupled to the binoculars 10 at different heights with respect to the binoculars 10). In some examples, the second end 420 can includes two apertures 438a, 438b. In other examples, the second end 420 can include more than two apertures 438. In some embodiments, each of the more than one aperture 438 can be threaded (e.g., female thread) to receive a threaded portion (e.g., male thread) of the stabilization support member 406. The stabilization support member 406 can be releasably coupled (or removably coupled) to one of the apertures 438 (e.g., 438a, 438b), thereby releasably coupling the headrest device 400 to the binoculars 10 at different heights. In this manner, the multiple apertures 438 provides an adjustable connection point to releasably secure the stabilization support member 406 to the wrap-around structure 404.

The headrest device 400 can be moved substantially vertically (e.g., upwards, downwards) among the two or more apertures 438 to position the headrest device 400 in a desired position and a connector can releasably couple the headrest device 400 in the desired position. In this manner, the two or more apertures 438 can be used to adjust the height (e.g., vertical position) of the stabilization support member 406 with respect to the binoculars 10. For example, in FIGS. 4A-4B, the stabilization support member 406 is coupled to aperture 438a (e.g., top aperture), such that the stabilization support member 406 is at a higher height (e.g., in a relatively higher vertical position). The stabilization support member 406 could be coupled to aperture 438b (e.g., bottom aperture) to position the stabilization support member 406 at a lower height (e.g., in a relatively lower vertical position). As previously discussed, in some embodiments, the headrest device 400 can include more than two apertures 438 and, accordingly, the vertical position of the stabilization support member 406 can be adjusted.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention. From the above description and drawings, it will be understood by those of ordinary skill in the art that the particular embodiments shown and described are for purposes of illustrations only and are not intended to limit the scope of the present invention. References to details of particular embodiments are not intended to limit the scope of the invention.

Reference to “embodiment”, “aspect,” or “example” means that a particular feature, structure, or characteristic described in connection with the embodiment is included in at least one embodiment of the disclosure. The appearances of these phrases in various places in the specification are not necessarily all referring to the same embodiment, nor are separate or alternative embodiments mutually exclusive of other embodiments. Moreover, various features are described which may be exhibited by some embodiments and not by others.

It will be appreciated that for simplicity and clarity of illustration, where appropriate, reference numerals have been repeated among the different figures to indicate corresponding or analogous elements. In addition, numerous specific details have been set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein. As such, elements of one system can be incorporated into any of the systems described herein. And, elements can be subtracted from any of the systems described herein without limitation.

What is claimed is:

1. A headrest device for stabilizing binoculars on a forehead of a user, the binoculars including a body extending from a user-facing end to an object-facing end, the body including a pair of barrels coupled together at a mid-section thereof, a focus knob at the user-facing end, and a tripod connector at the object-facing end and positioned opposite the focus knob, each of the pair of barrels including an eyepiece at the user-facing end, and an objective lens at the object-facing end, the device comprising:
a connector configured to releasably couple to the tripod connector;
a stabilizing support member; and
a wrap-around structure including a body including a first end, a second end opposite the first end, and an adjustable section extending between the first end and the second end, the first end having a first aperture for receiving the connector therethrough, the second end configured to couple to the stabilizing support member, wherein, when the connector extends through the first aperture and is releasably connected the tripod connector, the adjustable section of the body is positioned lengthwise along the mid-section of the binoculars, and the second end of the body is positioned above the eyepieces of the pair of barrels so as to centrally position the stabilizing support member for supporting the forehead of the user.

2. The headrest device of claim 1, wherein the second end of the body of the wrap-around structure is height adjustable so as to position the stabilizing support member at different heights on the forehead of the user.

3. The headrest device of claim 1, wherein the first aperture at the first end of the body of the wrap-around structure is an elongated aperture providing an adjustable connection point for releasably securing the connector to the tripod connector.

4. The headrest device of claim 1, wherein the adjustable section includes a threaded connection between a first member including the first end having the first aperture, and a second member including the second end.

5. The headrest device of claim 1, wherein the adjustable section is configured to adjust a length of the body of the wrap-around structure to accommodate binoculars of different sizes.

6. The headrest device of claim 1, wherein the connector includes a threaded end for being threadably received within the tripod connector.

7. The headrest device of claim 1, wherein the body includes a first member having a first elbow section, and a second member having a second elbow section, the adjustable section including a member configured to couple between the first and second members.

8. The headrest device of claim 1, wherein the adjustable section of the body is positioned lengthwise along and beneath the mid-section of the binoculars.

9. The headrest device of claim 1, wherein the adjustable section of the body is positioned lengthwise along and above the mid-section of the binoculars.

10. A method of stabilizing binoculars on the forehead of the user, the method comprising:
providing the headrest device of claim 1;
coupling the headrest device to the tripod connector of binocular;
positioning the stabilizing support member of the headrest device on the forehead of the user.

11. The method of claim 10, further comprising: pivotally adjusting a position of the stabilizing support member relative to the binoculars.

12. The method of claim 10, further comprising: adjusting a length of the adjustable section of the body of the wrap-around structure to accommodate a size of the binoculars.

13. The method of claim 10, further comprising: adjusting a height of the stabilizing support member.
